(19) United States
(12) Patent Application Publication
(10) Pub. No.: US 2012/0310675 A1
(43) Pub. Date: Dec. 6, 2012

(54) System and Method for Loss Checks Payable to Secured Party and Property Owner

(75) Inventor: Mary Binder, Oak Park, IL (US)

(73) Assignee: JPMorgan Chase Bank, N.A., New York, NY (US)

(21) Appl. No.: 11/733,236

(22) Filed: Apr. 10, 2007

Related U.S. Application Data
(60) Provisional application No. 60/832,734, filed on Jul. 21, 2006.

(51) Int. Cl. G06Q 40/08

(52) U.S. Cl. 705/4

(57) ABSTRACT

Methods of and systems for distributing insurance proceeds from an insurer are disclosed. Insurance proceeds may be distributed to a property owner and a party with a security interest in the property. In accordance with some embodiments, the methods general comprise the steps of determining the amount of insurance proceeds to pay, capturing banking information associated with the property owner, providing the insurance proceeds to the party with a security interest in the property, removing the amount of value the party with the security interest in the property is entitled to and providing the residual value to the property owner. Systems in accordance with some embodiments of the invention general comprise a data capture device configured to capture banking information associated with the property owner, and a processor configured to provide a potion of the insurance proceeds to a first banking institution associated with the party with a security interest in the property and configured to provide the residual insurance proceeds to a second banking institution associated with the property owner.

### BACKGROUND

The present invention is generally directed to systems and methods for the disbursement of insurance funds following a loss. More particularly, the present invention is related to an efficient manner of disbursing a portion of loss funds to a named loss payee and the residual value to the property owner.

Insurance is often sought for coverage of property. This may be at the property owner's own volition, or at the behest of a party that has a secured interest in the property. For example, a mortgage company with a secured interest in a home may require a homeowner maintain a certain amount of insurance coverage. Similarly, a finance company that provides financing to a customer to purchase a vehicle may likewise require insurance coverage of the vehicle.

In these situations, the party who has the secured interest is typically named as a “loss payee” on the insurance policy. In other words, should a loss occur, the secured party (e.g., mortgage company, financing company) will receive payment. After the amounts owed to the secured party are paid, the residual value may be distributed to the property owner (e.g., homeowner, vehicle owner).

Loss payments issued by insurance companies are typically in the form of paper drafts, naming both the secured party and the property owner as co-payees. Therefore, endorsements from both parties are generally required before the draft may be settled. Efforts to streamline the process of providing loss checks directly to property owners have provided for more timely delivery of checks to the property owners, but there are often difficulties in the property owner obtaining the necessary endorsements from the secured party and receiving value.

Presently, an insurance adjuster may issue a loss check to a property owner on-site in some situations. As discussed above, however, loss checks often name both the property owner and the secured party as co-payees. Accordingly, endorsements from both parties are required before settlement. If a property owner attempts to cash the loss check without the proper endorsement from the secured party, the transaction will be declined. A property owner must obtain the secured party's endorsement (e.g., by mailing the check to the secured party or by visiting the secured party's place of business) before cashing the loss check.

Under financing agreements and other contractual obligations, the secured party typically has a first right to the loss funds to satisfy any outstanding debt related to the property. Therefore, the loss funds are typically distributed to the secured party, who provides a check representing the residual funds to the property owner. The property owner may now endorse this check and obtain payment.

Complicating matters, is that in addition to funds intended to for property loss, insurers may additionally provide funds for other expenses. For example, in the case of a home being destroyed, an insurance company may provide funds designated as emergency living or housing expenses. In the case of a vehicle being destroyed, an insurance company may provide funds designated as covering transportation rental or other similar costs. In these types of situations, there may be an amount of funds that the secured party as a named loss payee is not entitled to. These funds, however may be tied up in the various transactions required for cashing a property loss check, and delay their delivery to the property owner.

In summary, in the event of a property loss, a property owner must undertake multiple steps before receiving any funds related to the loss. In some circumstances, these funds may be necessary for immediate and emergency use. A property owner generally must (1) meet with an insurance adjuster who may provide a loss check on site, or may provide payment at a later date; (2) provide the property owner's endorsement; (3) either obtain the security party's endorsement, or mail the loss check to the security party named as a loss payee for its endorsement; (4) wait for the security party as named loss payee to take funds related to any outstanding debt on the property in question and obtain another check representing the residual value; and (5) cash the check representing the residual value.

This process is inefficient, tedious, and under certain circumstances, prone to fraud and to unacceptable delays. In certain circumstances, the availability of banking institutions, postal service, and even telephone communication may be limited. For example, in the aftermath of the 2005 Hurricane Katrina that destroyed portions of the Gulf Coast, entire bank branches were destroyed and postal service was not effective. Property owners who obtained loss checks were forced to travel to an area where bank branches were functioning in order to obtain funds to support their families. However, because the security party's endorsement, as a named loss payees is necessary, these property owners were often turned away until such necessary endorsements were obtained. In such a situation, fraud is often prevalent in property owners forging the endorsements of other named loss payees (e.g., secured parties) in order to obtain much needed funds.

In addition, as noted above, some insurance policies may provide for emergency living expenses in the event of a full property loss. Although these funds may be intended for the immediate use of the property owner, they are unobtainable until all endorsements are met and the above-described process is followed.

Accordingly, it is desirable to provide systems and methods for providing more timely and more efficient payment of loss funds to both a property owner and a secured party. It is also desirable to provide such a system and method that reduces fraud.

### SUMMARY OF THE INVENTION

Aspects of the invention include methods of and systems for distributing insurance proceeds from an insurer are disclosed. Insurance proceeds may be distributed to a property owner and a party with a security interest in the property. In accordance with some embodiments, the methods general comprise the steps of determining the amount of insurance proceeds to pay, capturing banking information associated with the property owner, providing the insurance proceeds to the party with a security interest in the property, removing the amount of value the party with the security interest in the property is entitled to and providing the residual value to the property owner. Systems in accordance with some embodiments of the invention general comprise a data capture device configured to capture bank information associated with the property owner, and a processor configured to provide a potion of the insurance proceeds to a first banking institution associated with the party with a security interest in the property and configured to provide the residual insurance proceeds to a second banking institution associated with the property owner.

It is to be understood that both the foregoing general description and the following detailed description are exemplary and explanatory only, and are not restrictive of the invention as claimed. The accompanying drawings constitute a part of the specification, illustrate certain embodiments of the invention and, together with the detailed description, serve to explain the principles of the invention.

### DESCRIPTION OF THE DRAWINGS

In order to assist in the understanding of the invention, reference will now be made to the appended drawings, in which like reference characters refer to like elements. The drawings are exemplary only, and should not be construed as limiting the invention.

FIG. 1 is a block diagram of a system in accordance with some embodiments of the present invention.

FIG. 2 is a block diagram of a system in accordance with some embodiments of the present invention.

FIG. 3 is a block diagram of a system in accordance with some embodiments of the present invention.

FIG. 4 is a block diagram of a system in accordance with some embodiments of the present invention.

FIG. 5 is a block diagram of a system in accordance with some embodiments of the present invention.

FIG. 6 is a schematic diagram of a handheld device in accordance with some embodiments of the present invention.

FIG. 7 is a flow-chart depicting a method in accordance with some embodiments of the present invention.

### DETAILED DESCRIPTION OF THE INVENTION

Some embodiments of the present invention are illustrated in FIG. 1, and provide a system 10 for electronic communications between an insurance company 110, a secured party 120, and a property owner 130. The secured party 120 may be any entity that possesses an interest in the property insured (e.g., a mortgagor, a finance company, etc.). The secured party 120 may be named the loss payee on the insurance agreement. The property owner 130 may be any person or entity who possesses the property at issue, and who also may be entitled to insurance proceeds following a loss. The property owner 130 may also be entitled to additional benefits, such as emergency living or temporary housing expenses, which are discussed in more detail below. It is to be understood that financial transactions that occur between these parties (the insurance company, the secured party, and the property owner) may occur at the parties' respective banking institutions. In FIG. 1, however, for ease of understanding, financial transfers are illustrated as occurring directly between the parties.

When the insurance company 110 determines that insurance proceeds are to be paid, the insurance company 110 may request or otherwise capture information regarding the property owner's banking institution 130. The insurance company 110 may then provide payment directly to the secured party 120 and may pass along the captured banking information of the property owner 130. The secured party 120 may then provide any residual funds (funds left after the mortgage or other outstanding debt is satisfied) directly to the property owner's banking institution 130. In his manner, the property owner 130 may have quick access to the loss funds.

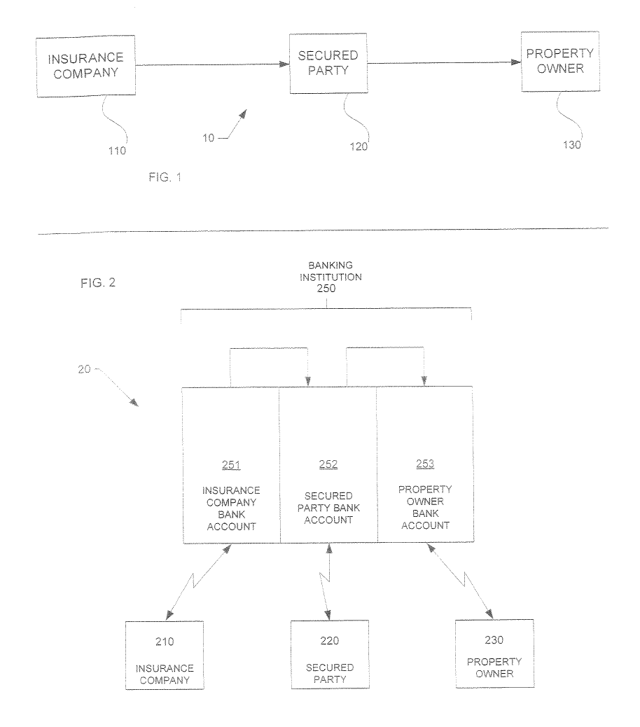

In general, the systems and methods in accordance with some embodiments of the present invention may be characterized by the relationship between the insurance company, the secured party, and the property owner. These relationships are discussed below in terms of financial institutions. In other words, there may be four (4) distinct scenarios. In each scenario, various communications and transactions in the prior art may be eliminated and streamlined, resulting in a property owner receiving insurance proceeds in an expedited manner, obtaining efficiencies in supporting the insurance companies' disbursement operations, and in improving the mortgage companies recovery operations. Each scenario is discussed in more detail below. In a first scenario, and that illustrated in FIG. 2, is a system 20 in which the insurance company 210 uses the same banking institution as the secured party 220 and the property owner 230. In other words, a single banking institution 250 may comprise an account of the insurance company 251, an account of the secured party 252, and an account of the property owner 253.

In such a situation, loss payments may be withdrawn from the insurance company's account 251 and transferred to the secured party's account 252. The amount necessary to satisfy the security interest (e.g., mortgage) may be taken, and any residual value may then be transferred to the property owner's account 253. In this manner, in a brief period of time all parties may have the funds to which they are entitled. By utilizing electronic transfers, manual transactions and trips to traditional “brick-and-mortar” banking institutions may be avoided.

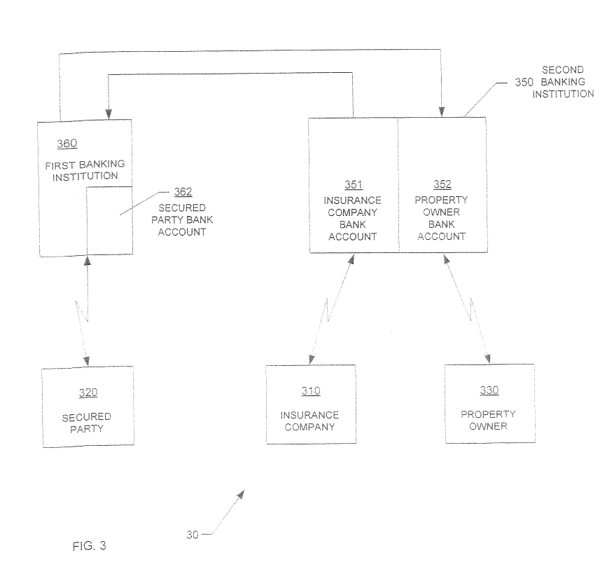

A second scenario, and that illustrated in FIG. 3 is a system 30 in which the insurance company 310 and property owner 330 may use a first banking institution 350, and where the secured party may use a second banking institution 360. The first banking institution 350 may comprise the insurance company's account 351 and the property owner's account 353. The second banking institution 360 may comprise the secured party's account 362. In this situation, depicted in FIG. 3, value transfers from the insurance company 310 to the secured party 320 may be between the insurance company's account 351 to the secured party's account 362. The secured party 320 may remove the amount of funds it is entitled to, and provide any residual value to the property owners' account 353. It is contemplated that if the insurance company 310 is aware of the respective amounts due to the secured party 320 and the property owner 330, the insurance company 310 may provide these amounts to both parties directly, rather than waiting for the secured party 320 to remove its funds and convey any residual value to the property owner 330.

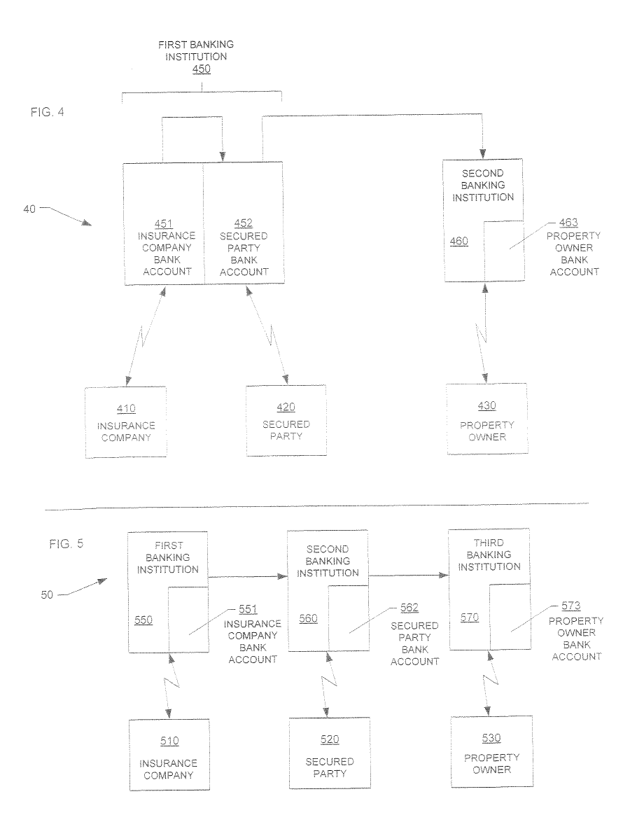

A third scenario, and that illustrated in FIG. 4 may be a system 40 in which an insurance company 410 and a secured party 420 have accounts 451, 452 respectively, at a first banking institution 450, and a property owner 430 has an account 463 at a second banking institution 460. In this system 40, insurance loss proceeds may be transferred from the insurance company's account 451 to the secured party's account 452 at the first banking institution 450. Residual value may be transferred to the property owner's account 463 at the second banking institution 460. It is again contemplated that if the insurance company 410 is aware of the respective amounts due to the secured party 420 and the property owner 3430, the insurance company 410 may provide these amounts to both parties directly, rather than waiting for the secured party 420 to remove its funds and convey the remained to the property owner 430.

Finally, a fourth scenario, and that illustrated by FIG. 5, may be a system 50 in which an insurance company 510 may have an account 551 at a first banking institution 550, a secured party 520 may have an account 562 at a second banking institution 560 and a property owner 530 may have an account 573 at a third banking institution 570. The insurance company 510 may transfer value from its account 551 to the secured party's account 561. The secured party 520 may then transfers any residual value to the property owner's account 573, where the property owner 530 may have immediate access to the value.

In order to expedite the transfer of value between parties, it is contemplated that such transfers be accomplished through electronic funds transfer systems, as known in the art, or by substitute checks, as also known in the art.

As noted above, it is commonplace for loss checks to name both property owner and the secured party as co-payees. Therefore, it may be necessary to obtain an endorsement from the property owner. In situations where the secured party and the property owner's banking institution are the same entity, it should be noted that under present banking laws, a bank may provide the endorsement of its customer. Therefore, provided that the bank has authorization (either at the time of the transactions or previously, such as in the financing agreement) the necessary property owner endorsement can be supplied. In the scenarios discussed above where the secured party and the banking institution are not the same entity, the property owner's endorsement may be supplied during the initial information capture of the property owner's banking institution, or may be supplied through other means. Other means may include through the use of a substitute check, or through other contractual agreements between the property owner, the secured party, and/or the banking institution.

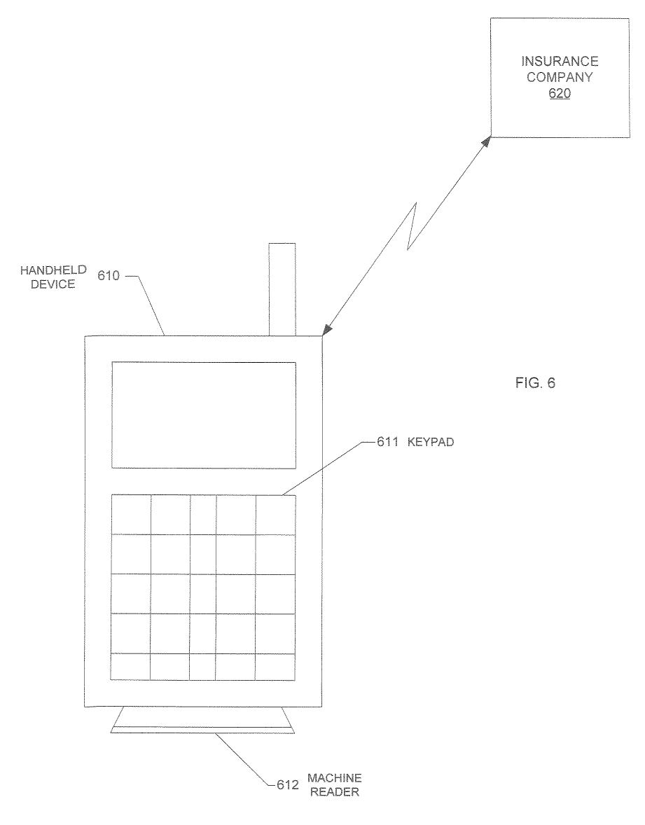

With reference to FIG. 6, in order to additionally expedite the transfer of value between parties, a handheld device 610 may be utilized. The handheld device 610 may be used by an insurance agent or adjuster employed by an insurance company 620. The handheld device 610 may be in communication with the insurance company 620 when the insurance agent or adjuster is in the field. Such communication may be wireless, and may utilize mobile technology, including but not limited to cellular and satellite technology. The handheld device 610 may also provide communications to the insurance company 620 via land-lines if more convenient.

The handheld device 610 may comprise numerous data input devices, such as but not limited to a keyboard 611 and/or a machine reader 612. The machine reader 612 may be an optical scanner, magnetic stripe reader, and/or bar code reader.

The handheld device 610 may be used by an insurance agent or adjuster for several reasons. The handheld device 610 may provide calculation tools that are necessary or useful for an insurance agent or adjuster in determining the amount of loss that is applicable to a particular claim. Upon determining the amount of loss payments a property owner may be entitled to, the insurance agent or adjuster may capture or otherwise input information relating to the property owner's banking institution (e.g., routing numbers, account numbers, etc.). This information may be entered into the handheld device 610 via any of the data input devices 611, 612. For example, a routing number and account number may be manually entered via the keyboard 611. Alternatively, the property owner's account information may be captured by swiping a debit card relating to the property owner's account through a magnetic stripe reader. Alternatively still, the property owner's account information may be captured through an optical recognition device, for example by scanning a cancelled check or a recent statement of the property owner's banking institution.

In situations where the relationships between the insurance company, the secured party, and the property owner require additional endorsements of the property owner, the handheld device 610 may include a means for capturing this signature, either physically or electronically.

Once the necessary information is captured by the handheld device 610 (e.g., the loss payment amount, the banking institution information of the property owner, the property owner's endorsement), such information may be conveyed to the insurance company 620 electronically. In this manner, the insurance company 620 may disburse loss funds in near real-time to a property owner and/or other named loss payee. The insurance company 620 may disburse funds through electronic transfer. Automated Clearing House transfers, or by issuing a file of images that can be used to generate substitute checks

Variations and multiple embodiments of the invention are possible. For example, substitute checks (e.g., files which, when printed, result in negotiable instruments) may be used in lieu of electronic transfer or ACH transfers.

As noted above, during particular circumstances and/or insurance claims, funds in addition to those representing property loss may be provided to a property owner. For example, should a complete home loss occur, an insurance policy may provide for emergency living expenses. These are funds which the secured party, as a named loss payee, is not entitled to; rather these funds are solely intended for the immediate use of the property owner. Accordingly, it is contemplated that funds designated as other than property loss value may be transferred directly from the insurance company to the property owner. A notice of such transfer may be provided to the secured party. Alternatively, funds designated as other than property loss value may immediately and automatically pass through the secured party's banking institution, such that the secured party can not and does not remove any value from the amount.

However, in certain circumstances funds intended solely for the property owner emergency living expenses) may not be specially designated, but may be part of the overall insurance claim payment. In order to provide necessary and timely delivery of such emergency funds, a threshold calculation may be employed. In such a threshold calculation, the insurance company may provide a single payment comprising both property loss value and emergency living expenses (or other such funds intended solely for the property owner) to a secured party. The secured party may immediately convey a portion of the single payment to the property owner. The portion may be an amount that falls under a pre-set threshold (for example, funds up to $10,000 may be immediately conveyed to a property owner following a full property loss). Alternatively, the portion may be a pre-set percentage of the total property loss value (e.g., 10%). Alternatively still, the portion may be a combination of these approaches, such that the property owner may be immediately conveyed 10% of the property loss value, up to $10,000.

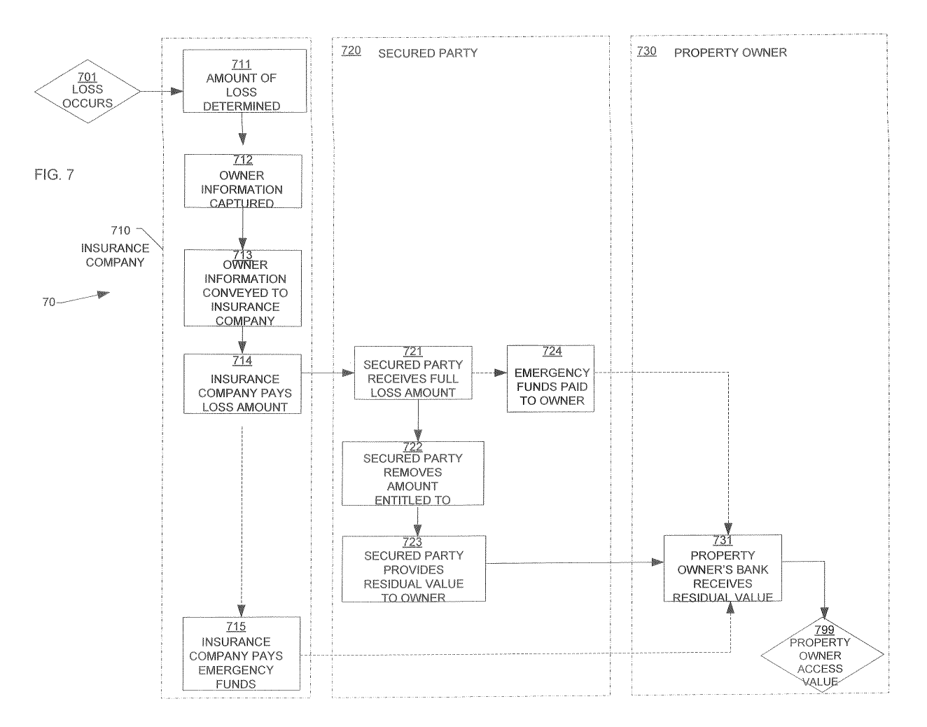

With reference to FIG. 7, a method 70 in accordance with some embodiments of the present invention will now be discussed. At step 701, a loss of property insured by an insurance company 710 and with a named loss payee 720 in addition to a property owner 730 occurs. The loss may be any type of property (e.g., a home, a car, a business, etc.). At step 711 the insurance company may determine the amount of payment that the property owner 730 and secured party are entitled to recover. Step 711 may be done by an insurance agent, employee, or adjuster in the field.

At step 712, the banking information of the property owner 730 may be captured. Such information capture may occur in the field through the use of a handheld device, as described above, or may occur through the property owner 730 providing such information directly to the insurance company 710 (e.g., verbal communication via the telephone, written communication via facsimile, etc.). Additionally, any necessary endorsements of the property owner may also be captured at step 712. Such endorsements may be recorded physically or electronically. Such endorsements may or may not be on a substitute check.

At step 713 the information regarding the property owner's banking institution may be conveyed to the insurance company 710. If the information regarding the property owner's banking institution was provided directly to the insurance company 710 rather than to an insurance agent, employee, or adjuster in the field, this step may be omitted.

At step 714 the insurance company 710 determines its final payment due to the property owner 730 and secured party (as named loss payee) 720. The final payment may include funds intended for purposes other than property loss value. For example, funds may be intended for emergency or temporary housing expenses (in the case of a full home loss) or intended for automobile rental (in the case of full automobile loss). The insurance company 710 may then convey the funds to the secured party 720. It is to be understood that the insurance company 710 may instruct its banking institution to transfer funds from its account to an account of the secured party 720. Such a transfer may be internal (where the insurance company and secured party both use the same banking institution, or where the secured party and the banking institution used by the insurance company are the same entity) or may be external (where the insurance company and the secured party use different bank institutions, or where the secured party is the same entity as a banking institution different than that used by the insurance company).

Note that at optional step 715, the insurance company 710 may convey funds intended for purposes other than property loss value (e.g., emergency or temporary living expenses) directly to the property owner 730.

At step 721 the secured party 720 may receive the funds representing the loss amount and any additional funds intended for purposes other than property loss value from the insurance company 710. At step 722 the secured party 720 may deposit the amount of the insurance payment that the secured party 720 is entitled to. The amounts that the secured party 720 is entitled to may be, but is not limited to, the amount that the property owner 730 is indebted to the secured party 720.

At step 723 the secured party 720 may convey any residual funds, or funds intended for purposes other than property loss value, to the property owner. Such a transfer may be internal (where the secured party and property owner both use the same banking institution, or where the secured party and the banking institution used by the property owner are the same entity) or may be external (where the secured party and property owner use different banking institutions, or where the secured party is the same entity as a banking institution different than that used by the property owner).

At optional step 724, funds designated as intended for purposes other than property loss value may be conveyed directly to the property owner 730. Alternatively, a portion of the value of the property loss value may be immediately conveyed to the property owner 730. This step may be an option that could be utilized in times of crisis.

At step 731 the property owner 730 receives the residual funds from the secured party 720, as well as any funds intended for purposes other than property loss value. The property owner 730 may optionally receive such funds intended for purposes other than property loss directly from the insurance company 710. The property owner 730 may receive these funds in the form of an automatic deposit into the property owner's banking institution, information of which was captured in step 712 by the insurance company.

At step 799, the property owner 730 has full and immediate access to funds that the property owner 730 is rightfully entitled to in full, the secured party 720 having previously removed the portion of the funds to which it was entitled to.

The embodiments of the present invention are not to be limited in scope by the specific embodiments described herein. For example, although the discussion above primarily discusses a single insurance company, a single secured party, and a single property owner, the present invention is to cover multiple parties. For example, insurance coverage may be provided by two carriers (e.g., a direct policy carrier, and umbrella coverage). Property may similarly be have more than one party with a security interest therein (e.g., a first mortgage and a second mortgage). And property may have multiple owners (e.g., tenants in common, joint tenants).

Indeed, various modifications of the embodiments of the present inventions, in addition to those described herein, will be apparent to those of ordinary skill in the art from the foregoing description and accompanying drawings. Thus, such modifications are intended to fall within the scope of the following appended claims. Further, although some embodiments of the present inventions have been described herein in the context of a particular implementation in a particular environment for a particular purpose, those of ordinary skill in the art will recognize that its usefulness is not limited thereto and that the embodiments of the present inventions can be beneficially implemented in any number of environments for any number of purposes.

Accordingly, the claims set forth below should be construed in view of the full breadth and spirit of the embodiments of the present inventions as disclosed herein.

1. A method for distributing insurance proceeds following a loss of property, the method comprising the steps of:
determining the amount of insurance proceeds to distribute;
capturing banking information associated with an owner of the property;
providing a portion of the payment to a named loss payee; and
providing the residual vale to the owner of the property.

2. The method of distributing insurance proceeds following a loss of property of claim 1, further comprising:
providing payment of funds other than insurance proceeds to the owner of the property, where in the funds are intended to provide immediate financial assistance to the owner of the property.

3. The method of distributing insurance proceeds following a loss of property of claim 2, wherein the funds other than insurance proceeds are emergency living and housing expenses.

4. The method of distributing insurance proceeds following a loss of property of claim 1, wherein the named loss payee is a party who has a security interest in the property.

5. The method of distributing insurance proceeds following a loss of property of claim 1, wherein the residual value is the value remaining after the named loss payee is paid the amount of the proceeds that it is entitled to.

6. A method of distributing insurance proceeds from an insurer to a property owner and a party with a security interest in the property using at least one computer processor over a network, the method comprising the steps of:
determining, by the at least one computer processor, the amount of insurance proceeds to pay using one or more calculation tools;
capturing, electronically, by a wireless portable electronic device comprising a data capture device, banking information associated with the property owner, comprising electronically capturing at least the property owner's endorsement;
providing at least a portion of the insurance proceeds to the party with a security interest in the property, wherein the at least a portion of the insurance proceeds are provided from a first banking institution associated with the insurer to a second banking institution associated with the party with a security interest in the property; and
providing a residual value to the property owner via the network, wherein the residual value is an amount of insurance proceeds, determined by the one or more calculation tools, that the party with a security interest in the property is not entitled to and providing the residual value to the property owner comprises providing the residual value to a third banking institution associated with the property owner.

7. The method of claim 6, wherein the step of capturing banking information associated with the property owner comprises capturing the property owner's account information.

8. (canceled)

9. (canceled)

10. The method of claim 6, wherein the step of capturing the property owner's endorsement comprises the property owner endorsing a check.

11. The method of claim 6, wherein the step of capturing the property owner's endorsement comprises the property owner endorsing a substitute check.

12. (canceled)

13. (canceled)

14. The method of claim 6, wherein first banking institution and the second banking institution are the same entity.

15. The method of claim 6, wherein first banking institution and the party with a security interest in the property are the same entity.

16. The method of claim 6, wherein the step of providing the insurance proceeds to the party with a security interest in the property is accomplished through electronic funds transfer systems.

17. The method of claim 6, wherein the step of providing the insurance proceeds to the party with a security interest in the property is accomplished through automated clearing house systems.

18. (canceled)

19. The method of claim 6, wherein the second and third banking institutions are the same entity.

20. The method of claim 6, wherein the first and the third banking institution are the same entity.

21. The method of claim 6, wherein the step of providing the residual value to the property owner is accomplished through electronic funds transfer systems.

22. The method of claim 6, wherein the step of providing the residual value to the property owner is accomplished through automated clearing house systems.

23. The method of claim 6, further comprising the steps of:
providing at least a portion of the residual value of the insurance proceeds directly to the property owner.

24. The method of claim 23, wherein the portion of the insurance proceeds provided directly to the property owner are funds intended to provide immediate financial assistance to the owner of the property.

25. The method of claim 23, wherein the portion of the insurance proceeds provided directly to the property owner are emergency living and housing expenses.

26. The method of claim 23, wherein the portion of the insurance proceeds provided directly to the property owner is a predetermined percentage of the insurance proceeds.

27. The method of claim 23, wherein the portion of the insurance proceeds provided directly to the property owner is a predetermined amount of the insurance proceeds.

28. A handheld device for capturing banking information associated with an owner of insured property subjected to a loss, comprising:
a wireless communication module, wherein the communication module communicates with an processor at an insurance company at a remote location;
a data input module, wherein the data input module comprises a machine reader; and
a display screen.

29. The handheld device for capturing banking information associated with an owner of insured property subjected to a loss of claim 28, wherein the machine reader may be selected from the group consisting of: a magnetic stripe reader, a bar code reader, an optical scanner and any combination thereof.

30. The handheld device for capturing banking information associated with an owner of insured property subjected to a loss of claim 28, wherein the data input module comprises means for recording the owner's endorsement.

31. A system for distributing insurance proceeds from an insurer to a property owner and a party with a security interest in the property, wherein the system comprises:
a wireless, portable electronic data capture device, configured to capture banking information associated with the property owner, wherein the captured banking information comprises capturing at least an electronic endorsement from the property owner; and
a computer processor, configured to provide a portion of the insurance proceeds, determined using one or more calculation tools, to a first banking institution associated with the party with a security interest in the property, wherein the insurance proceeds are provided from a first banking institution associated with the insurer to a second banking institution associated with the party with a security interest in the property, and configured to provide residual insurance proceeds to a third banking institution associated with the property owner.

32. The system of claim 31, wherein the wireless, portable electronic data device comprises a machine reader.

33. The system claim 32, wherein the machine reader is selected from the list consisting of a magnetic stripe reader, a bar code scanner, an optical scanner, and any combination thereof.

34. The system of claim 31, wherein the wireless, portable electronic data capture device is configured to capture the endorsement of the property owner.

35. The method of claim 6, wherein the one or more calculation tools are configured to be used by at least one of an insurance agent, employee, and field adjuster.

36. The system of claim 31, wherein the one or more calculation tools are configured to be used by at least one of an insurance agent, employee, and field adjuster.

37. The method of claim 6, further comprising determining additional proceeds to be provided to the property owner, wherein the additional proceeds are funds not directly related to property loss value.

38. The method of claim 37, wherein the additional proceeds comprise emergency or temporary living expenses.

39. The system of claim 31, wherein the computer processor determines additional proceeds to be provided to the property owner, wherein the additional proceeds are funds not directly related to property loss value.

40. The system of claim 39, wherein the additional proceeds comprise emergency or temporary living expenses.
